(19) United States
(12) Patent Application Publication
(10) Pub. No.: US 2026/0340093 A1
(43) Pub. Date: Oct. 29, 2026

(54) AGENTIC ARTIFICIAL INTELLIGENCE THREAT DETECTION AND PREVENTION

(71) Applicant: The United States of America, as represented by the Secretary of the Navy, San Diego, CA (US)

(72) Inventors: David Leonard Voelker, San Diego, CA (US); Tamanu Lowkie, Summerville, SC (US)

(73) Assignee: THE UNITED STATES OF AMERICAN, AS REPRESENTED BY THE SECRETARY OF THE NAVY, (omitted)

(21) Appl. No.: 19/190,892

(22) Filed: Apr. 28, 2025

(51) Int. Cl. G06F 21/31; H04L 9/40; H04L 41/16

(52) U.S. Cl. CPC G06F 21/316; H04L 41/16; H04L 63/1416

(57) ABSTRACT

A method for detecting and preventing threats in a computing environment using an agentic artificial intelligence large language model includes creating and training one or more artificial neural networks that individually function as a threat detection agent operating with an authorization microservice. The one or more trained artificial neural networks ingest and analyze individual behavior data compiled on a database for each individual user. The individual behavior data is evaluated to determine a citizenship threat probability for each individual user. The citizenship threat probability for each individual user is compared to a threshold citizenship value. Individual user access to one or more applications via the authorization microservice is revoked when the citizenship threat probability is below the threshold citizenship value.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor. Licensing and technical inquiries may be directed to the Office of Research and Technical Applications, Naval Information Warfare Center Pacific, Code 72120, San Diego, CA, 92152; (619) 553-5118; NIWC_Pacific_T2@us.navy.mil. Reference Navy Case Number XXXXXX.

### BACKGROUND

Artificial intelligence (AI) involves computer systems providing functions that include human intelligence. Some examples of the functions include reasoning, learning, problem-solving, understanding natural language, recognizing patterns, and making decisions. AI may include machine learning, neural networks, natural language processing, computer vision, and robotics. Through these capabilities, AI systems can analyze vast amounts of data, identify insights, and automate processes. As a result, AI systems have been used in chatbots, autonomous vehicles, virtual assistants, facial recognition, and many other applications.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is an example of a method for detecting and preventing threats in a computing environment using an agentic artificial intelligence large language model described herein;

FIG. 2 is an example of training the artificial neural network used in the method described herein;

FIG. 3 is an example of the agentic artificial intelligence framework for the method described herein;

FIG. 4 is an example of four threat detection agents linked through a series of interconnected outputs;

FIG. 5 is an example of four threat detection agents are linked in-series where a threat detection agent feeds another threat detection agent;

FIG. 6 is an example of six threat detection agents where the Remote Desktop Protocol (RDP) threat detection agent detects a threat via an output and sends that output to the authorization and administration services; and

FIG. 7 is an example of a threat detection agent with a tiered threshold citizenship value.

### DETAILED DESCRIPTION

In most artificial intelligence (AI) threat detection methods, the models ingest data and make decisions based on multiple neural networks and multiple different types of data simultaneously. For example, multiple neural networks can be used to manage usage behavior and usage patterns of users simultaneously. These methods require the user to carefully verify the AI model ensure the neural networks are not creating false positive threats to a system. Verifying the results of this type of AI method is challenging due to so many different inputs being evaluated simultaneously. As a result, these methods can be difficult to train, difficult or impossible to understand and manage for the user, and prone to error or misinterpretation of the data.

In the method herein, the AI threat detection method employs a single neural network that reviews the data sequentially using a single criteria or source of data for each evaluation point before moving onto another source of data for further verification. For example, the AI model is preset to have a threshold for the first criteria using specific data inputs for those criteria to determine a probability that a threat exists. If the threshold is met, the AI model moves on to another set of criteria using specific data inputs for that next set of criteria. The AI model uses all the criteria to revoke user access to applications on a computer network or notify an administrative user of a detected threat indicator if combined criteria of a user meet a certain value. Therefore, in the method herein, the AI model employs a method that is easier to train, more user friendly, and less prone to error or misinterpretation compared to traditional AI threat detection methods.

The method for detecting and preventing threats in a computing environment using an agentic artificial intelligence large language model herein includes creating and training one or more artificial neural networks that individually function as a threat detection agent operating with an authorization microservice. The trained artificial neural network ingests and analyzes individual behavior data compiled on a database for each individual user. The individual behavior data is evaluated to determine a good citizenship threat probability for each individual user. The citizenship threat probability for each individual user is compared to a threshold citizenship value. Individual user access to one or more applications via the authorization microservices is revoked when the citizenship threat probability is below the threshold citizenship value.

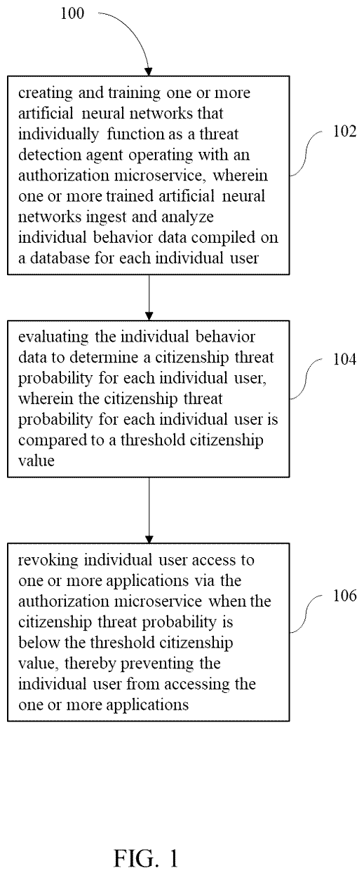

Referring now to FIG. 1, an example of the method 100 for detecting and preventing threats in a computing environment using an agentic artificial intelligence large language model is shown. The method 100 includes creating and training one or more artificial neural networks (ANNs) that individually function as threat detection agents operating with an authorization microservice. The ANNs may function as a threat detection agent, such as any threat detection agent tool. For example, a citizenship determination tool, a rule breaker tool, an adversarial threat determination tool, an advanced persistent threat determination tool, and combinations thereof interoperating with security information and event management tools. The ANNs are trained with training data on a database 102. The database may be any database capable of storing training data the ANNs may access, such as a Structured Query Language (SQL) database. An ANN is created by first inputting a set of rules for the ANNs to follow. Any set of rules may be used. For example, an Attribute Based Access Control (ABAC) standard may be used as the set of rules. The one or more ANNs with preset rules are then trained using training data. In an example, the one or more ANNs may be trained using any known training data and may employ back propagation to set weights for hidden layers of the ANN. In an example, MITRE Adversarial Tactics, Techniques, and Common Knowledge (ATT&CK) data may be used to train the ANN. In another example, the training data may be historical adversary attacks data, pre-incident indicators data, and combinations thereof. In an example, the one or more ANNs may be trained until the ANN is as close to 100% citizenship threat probability as possible. The one or more ANNs are restricted to an individual application container to run a single thought process to provide a conclusion based on a high probably threshold.

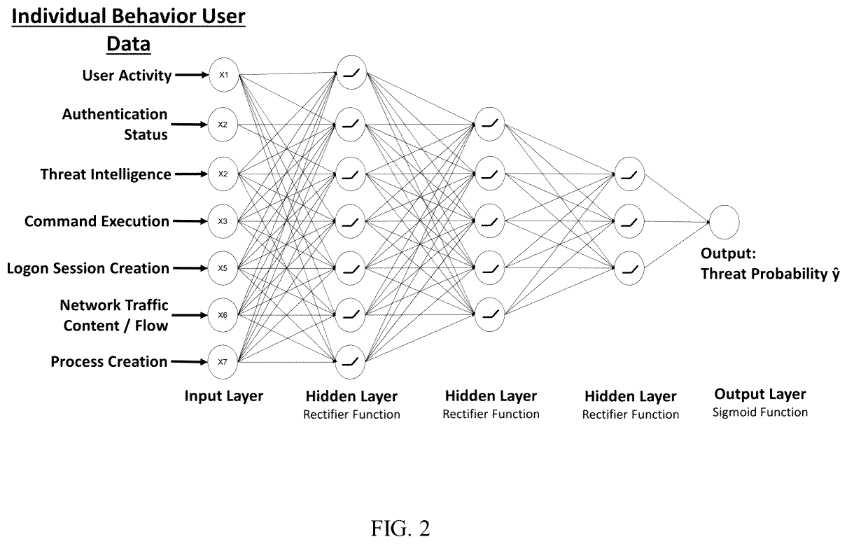

An example of the training process of the one or more ANNs is shown in FIG. 2. In an example, the one or more ANN can be a deep learning ANN with a single thought process to ingest and analyze individual behavior data. Individual behavior data includes user data and system data. In one example, each ANN ingests and analyzes a single type of individual behavior data as inputs in a series of interconnected outputs and the results of each ANN combine to provide an output probability to a large language model. In another example, each ANN ingests and analyzes a single type of individual behavior data sequentially as inputs for another ANN until the final ANN provides an output probability to the large language model. The individual behavior data may be any specific threat indicator. Some examples of the individual behavior data include login attempts, access patterns, usage behavior, timestamps, user activity, authentication status, command execution, threat intelligence, logon session creation, network traffic content or flow, process creation, or a combination thereof. In an example shown in FIG. 2, each category of individual behavior data is analyzed with a single ANN. Each ANN ingests individual behavior data at the input layer, the hidden layers run weighted rectifier functions, and in the output layer, a Sigmoid provides a citizenship threat probability, which is discussed in greater detail below. This process continues if the citizenship threat probability is greater than a threshold citizenship value, which is represented by a threat probability.

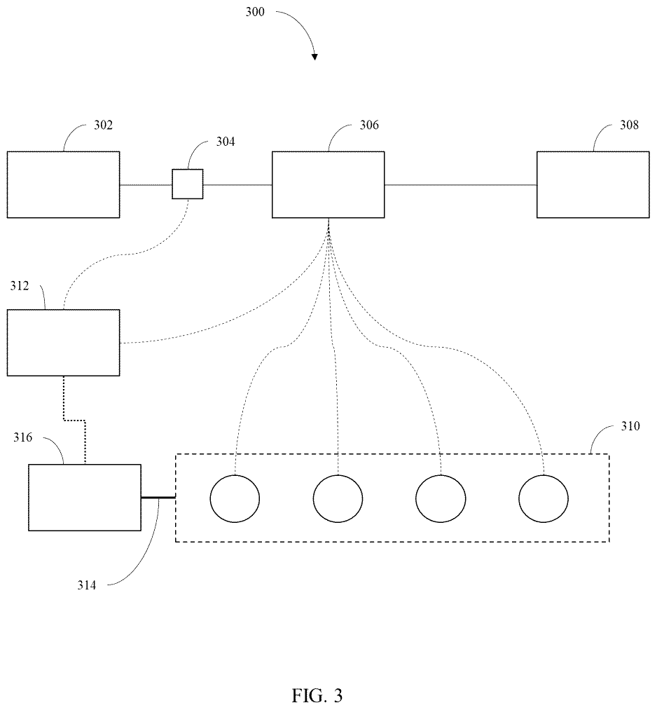

Once the one or more ANNs are trained, the trained one or more ANNs are used as part of an agentic threat detection framework. FIG. 3 shows an example of an agentic threat detection framework 300. The dashed lines in FIG. 3 are for illustrative purposes only to aid in viewing and should not be construed as being limiting or directed to a particular material or materials. Each ANN functions as a threat detection agent 310 that ingests and analyzes a specific type or specific types of individual behavior data compiled on a database for each individual user accessing the network via a computing device 302. The individual behavior data may be stored on any type of database accessible either locally or wirelessly to the one or more threat detection agents 310 and the large language model 316. The large language model 316 may be stored on any type of database capable of storing and running the large language model 316. The large language model 316 may be stored on any type of database that allows the large language model 316 to access the one or more threat detection agents 310 and the authorization and administration system 312. In an example, the database for the large language model 316 may be an Online Analytical Processing (OLAP) database. The individual behavior data can be any of the individual behavior data previously described herein. Each threat detection agent 310 is connected to an authorization microservice via an application container 306, which functions as a network tap for the one or more threat detection agents 310 to access the data flowing from the computing device 302 to the one or more applications 308. In one example, the authorization microservice runs in the application container 306 and is connected to a single computing device 302. In another example, the authorization microservice runs in an application container 306 and is connected to two or more computing devices 302. The authorization microservice runs a single process with allocated compute, memory, storage, and networks input/output. This allows individual threat detection agents 310 (i.e., ANNs) to be removed, exchanged, updated or a combination thereof from the framework 300 while keeping the framework 300 operational. For example, if each threat detection agent 310 is deployed and connected to the network via the application container 306, each threat detection agent 310 has a dedicated application microservice. The application container 306 is set to deny all traffic by default. When authorized user traffic is permitted, the authorized user traffic follows between the computing device 302, the one or more applications 308, and copied to the one or more threat detection agents 310 for threat detection. In this example, the one or more threat detection agents 310 provide a set of output probabilities 314 from each threat detection agent 310. Each of the four threat detection agents 310 produce output probabilities 314 that answer one question. For example, asking whether an authenticated user is a good citizen (i.e., a citizen threat probability above the threshold), a rule breaker, an adversarial threat, an advanced persistent threat (APT), or a combination thereof. As a result, each threat detection agent 310 provides a data point as an output probability 314 to combine to a set of output probabilities 314. In another example, the output probability 314 provided by one threat detection agent 310 can be used as an input factor for another threat detection agent 310. The output probability 314 of each threat detection agent 310 are input factors for another threat detection agent 310, which then provides a cumulative output probability 314 to analyze to determine the citizenship threat probability of each individual user.

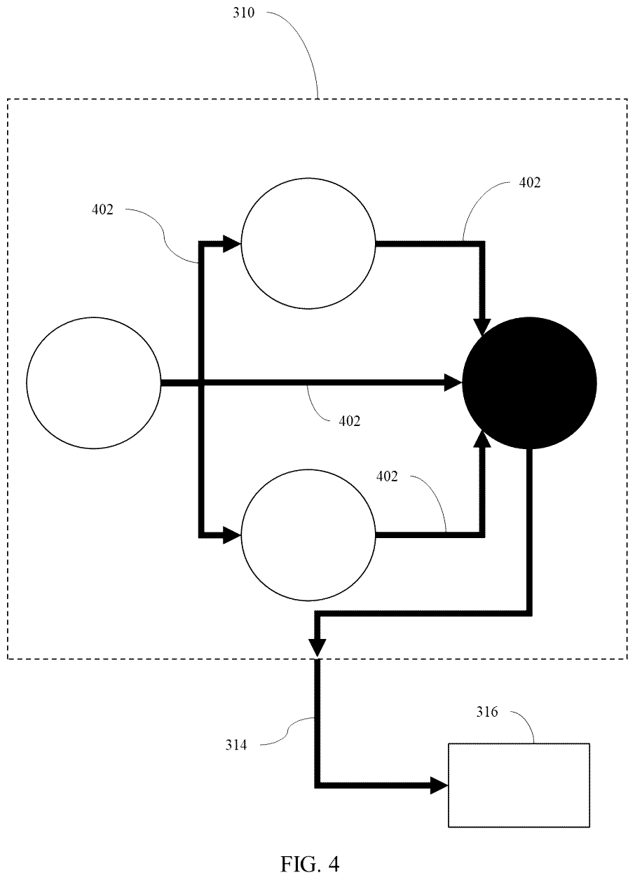

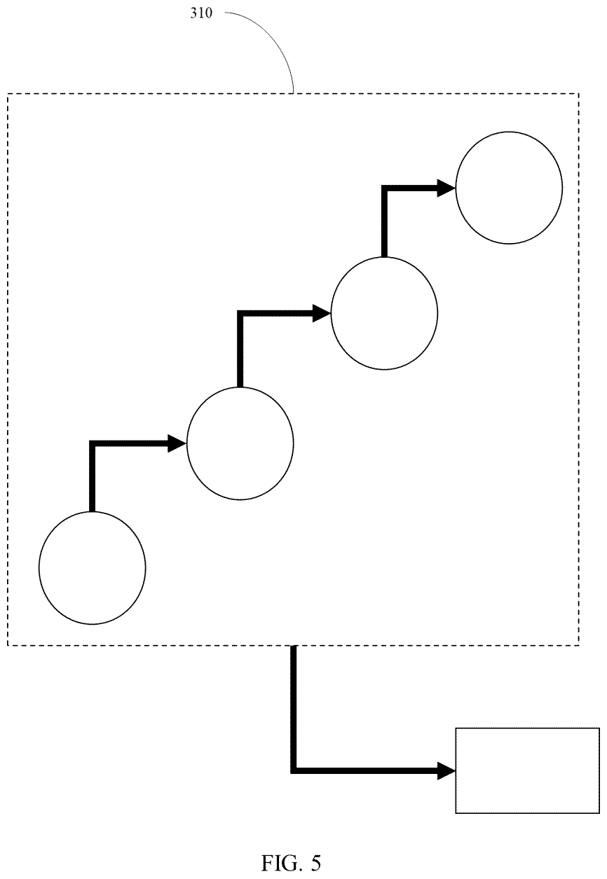

In an example, in FIG. 4, one or more trained threat detection agents 310 as ANNs are shown. In this example, the configuration of the threat detection agents 310 includes each threat detection agent 310 ingesting and analyzing a single type of individual behavior data as inputs 402 in a series of interconnected outputs. The results of each threat detection agent 310 combine to provide a prompted output probability 314 to the large language model 316 stating whether an individual user is a threat by providing a citizenship threat probability. In FIG. 5, another example is shown of the one or more trained threat detection agents 310 as ANNs. In this example, the configuration of threat detection agents 310 includes each individual threat detection agent 310 ingesting and analyzing a single type of individual behavior data sequentially as inputs 402 for another threat detection agent 310 and each individual threat detection agent 310 also providing an output probability 314 to the large language model 316 simultaneously to providing inputs 402 for another threat detection agent 310.

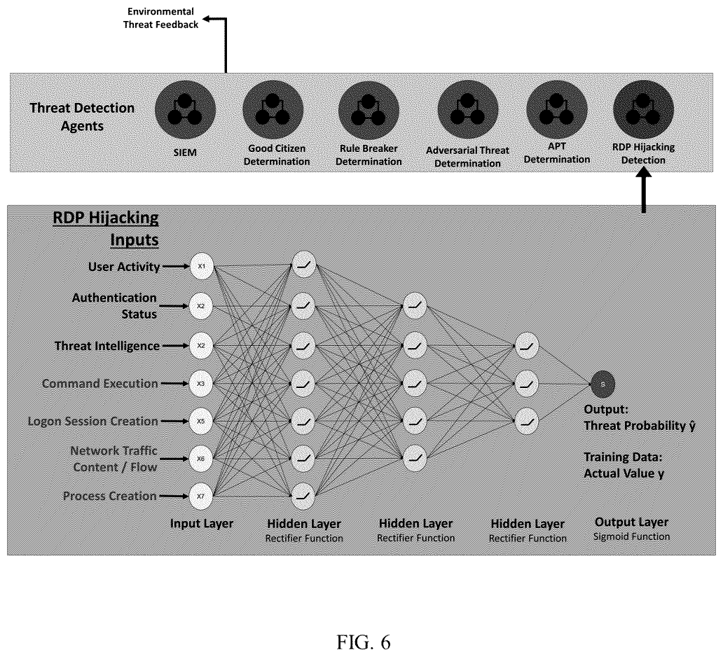

In another example, in FIG. 6, a specific threat detection agent 310 is shown. In this example, a Remote Desktop Protocol (RDP) Hijacking Detection threat detection agent generates an output threat probability using individual behavior data inputs, such as user activity, authentication status, threat intelligence, command execution, logon session creation, network traffic content or flow, and process creation. The RDP Hijacking Detection threat detection agent ingests the individual behavior data at the input layer, the hidden layers run weighted rectifier functions, and in the output layer, a Sigmoid provides a citizenship threat probability. Each of the threat detection agents 310 shown run similar functions using similar or different individual behavior data inputs. In FIG. 6, the threat detection agents 310 include Security Information and Event Management (SIEM), Good Citizenship determination, Rule Breaker Determination, Adversarial Threat Determination, Adversarial Persistent Threat (APT) Determination, and RDP Hijacking Detection. For each individual user, the threat detection agents 310 combine their outputs to provide environmental threat feedback as a citizenship threat probability 314 to the authorization and administration system 312.

Referring back to FIG. 1, the method 100 includes evaluating the individual behavior data to determine a citizenship threat probability for each individual user 104. The ANNs are calculating the citizenship threat probability as a threat detection agent for each individual user and sending that determination to the authorization and administration system (depicted in FIG. 3 as 312). The citizenship threat probability for each individual user is compared to a threshold citizenship value. The threshold citizenship value can be set at any value by system administrators. For example, the citizenship threshold value can be 70%, the one or more ANNs determine a citizenship threat probability for each individual criteria, the authorization and administration system receives the citizenship threat probability for each criterion from the one or more ANNs, and the authorization and administration system determines cumulative citizenship threat probability above 70%, the individual user can maintain access to the one or more applications. If the cumulative citizenship threat probability is below 70%, the individual user can have access to the network revoked.

In another example, the citizenship threat threshold can be tiered with a threshold set at 70% and 50%. In a tiered citizenship threat threshold, if a citizenship threat probability of an individual user is below 70%, but above 50%, the user can have access to the one or more applications revoked but still have access to the authorization and administration system. If the citizenship threat probability is below 50%, the individual user can have their access revoked to the network. In yet another example, the threshold citizenship value is dynamically adjusted. For example, if environmental factors indicate a high likelihood of a threat, the threshold citizenship value can be adjusted to 90%. Once the likelihood of a threat is no longer present, the threshold can be reduced back to 70%.

Referring back to FIG. 1, the method 100 includes revoking individual user access to one or more applications via the authorization microservice when the citizenship threat probability is below the threshold citizenship value, thereby preventing the individual user from accessing the one or more applications 106. In an example, revoking individual user access to one or more applications can be accomplished by revoking access to specific applications, revoking access to the network and, by extension, to the one or more applications, revoking access via a systems administrator after the systems administrator receives notice of a threat, or a combination thereof. Any other automated means of revoking individual user access to the one or more applications may be used. As previously stated herein, the threshold citizenship value can be static, dynamic, or tiered. When using a static or dynamic threshold citizenship value, any individual citizenship threat probability below the threshold citizenship value revokes access for the individual user. However, a dynamic threshold citizenship value can be adjusted depending on environmental factors. For example, dynamic threshold citizenship value can be adjusted based on historical citizenship threat probability, the sensitivity of application or content being viewed, or the number of threats attempted on the network. A tiered threshold citizenship value can have specific access revocations depending on the level threshold citizenship value being met. In some examples, individual users can be enabled to request a user access review through the authorization microservice. This would allow a system administrator to review the individual user account and remove the revocations if access was revoked in error. In another example, a notification is generated to system administrators when the citizenship threat probability is below the threshold citizenship value. In this example, the system administrator can make a determination based on the notification whether to revoke access to the network as a whole, specific access (e.g., to one or more applications), or maintain access for the individual user. In an example, the method 100 enables evaluation of hundreds of thousands of user connections access to the network. In another example, the method 100 has no limit to the number of user connections being evaluated and is dependent on the compute, memory, storage and network I/O capacity of the system.

Referring back to FIG. 3, the authorization microservice includes administrative access to revise individual user access to the network via the authorization and administration system 312. The authorization and administration system 312 controls whether the application container is in deny mode or permit and tap mode. In an example, the authorization and administration system 312 can be to control the data flow in any known way. The authorization and administration system 312 is connected to the network via the out of band connection to the computing device 302, the Secure Access Service Edge (SASE) 304, and the application container 306. The SASE 304 enforces data access policies that permit only authenticated users that have at least one privilege granted into the network (i.e., a Policy Enforcement Point (PEP)). The SASE 304 also functions as a Software Defined Wide Area Network (SD-WAN) management device. In an example, the SASE 304 may accept permit and tap or deny instructions from authorization and administration system 312, via the out of band connection to the computing device 302 and the application container 306. In one example, the authorization and administration system 312 allows a system administrator to manually revoke individual user access to the network via the SASE 304. In another example, the authorization and administration system 312 may automatically revoke individual user access to the network when the citizenship threat probability is below the threshold citizenship value as previously described herein via the SASE 304.

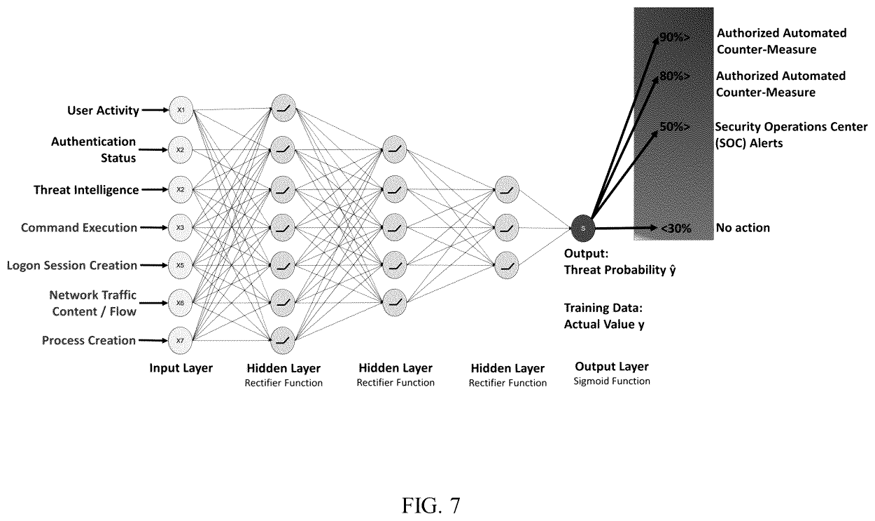

Referring now to FIG. 7, an example of the method 100 is shown. This example shows a threat detection agent 310. The threat detection agent 310 in this example generates an output threat probability using individual behavior data inputs, such as user activity, authentication status, threat intelligence, command execution, logon session creation, network traffic content or flow, and process creation. The threat detection agent 310 ingests the individual behavior data at the input layer, the hidden layers run weighted rectifier functions, and in the output layer, a Sigmoid provides a citizenship threat probability. In this example, a tiered citizenship threat threshold is used. If an individual user has a citizenship threat probability of 50% or less, for example 30%, no action is taken on the individual user. If an individual user has a citizenship threat probability between 80% and 50%, an alert is provided to the security operations center (SOC) for a system administrator to evaluate the user. If an individual user has a citizenship threat probability of 80% or more, an automated revocation of an individual user access to one or more applications is performed.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 0.1 to about 20 should be interpreted to include not only the explicitly recited limits of from about 0.1 to about 20, but also to include individual values, such as 3, 7, 13.5, etc., and sub-ranges, such as from about 5 to about 15, etc.

In describing and claiming the examples disclosed herein, the singular forms “a”, “an”, and “the” include plural referents unless the context clearly dictates otherwise.

What is claimed is:

1. A method for detecting and preventing threats in a computing environment using an agentic artificial intelligence large language model, comprising:
creating and training one or more artificial neural networks that individually function as a threat detection agent operating with an authorization microservice, wherein one or more trained artificial neural networks ingest and analyze individual behavior data compiled on a database for each individual user;
evaluating the individual behavior data to determine a citizenship threat probability for each individual user, wherein the citizenship threat probability for each individual user is compared to a threshold citizenship value; and
revoking individual user access to one or more applications via the authorization microservice when the citizenship threat probability is below the threshold citizenship value, thereby preventing the individual user from accessing the one or more applications.

2. The method of claim 1, wherein the one or more trained artificial neural networks each individually ingest and analyze a single type of individual behavior data in a series of interconnected outputs to a large language model or sequentially as inputs for another artificial neural network and the large language model.

3. The method of claim 1, wherein the one or more artificial neural networks function as threat detection agents selected from a group consisting of a citizenship determination tool, a rule breaker tool, an adversarial threat determination tool, an advanced persistent threat determination tool, and combinations thereof interoperating with security information and event management tools.

4. The method of claim 1, wherein the database is an online analytical processing database.

5. The method of claim 1, further comprising removing, exchanging, updating or a combination thereof the trained artificial neural networks.

6. The method of claim 1, wherein the authorization microservice includes administrative access to revise individual user access to the network.

7. The method of claim 1, wherein the individual behavior data compiled on the database includes login attempts, access patterns, usage behavior, timestamps, user activity, authentication status, command execution, threat intelligence, logon session creation, network traffic content or flow, process creation, or a combination thereof.

8. The method of claim 1, further comprising enabling individual users to request a user access review through the authorization microservice.

9. The method of claim 1, further comprising generating a notification to system administrators when the citizenship threat probability is below the threshold citizenship value.

10. The method of claim 1, wherein the threshold citizenship value is dynamically adjusted.

11. The method of claim 1, wherein the one or more artificial neural networks are trained with historical adversary attack data, pre-incident indicator data, and combinations thereof.

12. A method for detecting and preventing threats in a computing environment using an agentic artificial intelligence large language model, comprising:
creating and training one or more artificial neural networks that individually function as a threat detection agent operating with an authorization microservice, wherein one or more trained artificial neural networks each individually ingest and analyze a single type of individual behavior data in a series of interconnected outputs to a large language model or sequentially as inputs for another artificial neural network and the large language model;
evaluating the individual behavior data to determine a citizenship threat probability for each individual user, wherein the citizenship threat probability for each individual user is compared to a threshold citizenship value; and
revoking individual user access to one or more applications via the authorization microservice when the citizenship threat probability is below the threshold citizenship value, thereby preventing the individual user from accessing the applications.

13. The method of claim 12, wherein the artificial neural networks function as threat detection agents selected from a group consisting of a, a citizenship determination tool, a rule breaker tool, an adversarial threat determination tool, an advanced persistent threat determination tool, and combinations thereof interoperating with security information and event management tools.

14. The method of claim 12, wherein the database is an online analytical processing database.

15. The method of claim 12, further comprising removing, exchanging, updating or a combination thereof the trained artificial neural networks.

16. The method of claim 12, wherein the authorization microservice includes administrative access to revise individual user access to the network.

17. The method of claim 12, wherein the individual behavior data compiled on the database includes login attempts, access patterns, usage behavior, timestamps, user activity, authentication status, command execution, threat intelligence, logon session creation, network traffic content or flow, process creation, or a combination thereof.

18. The method of claim 12, further comprising generating a notification to system administrators when the citizenship threat probability is below the threshold citizenship value.

19. The method of claim 12, wherein the threshold citizenship value is dynamically adjusted based on current environmental factors.

20. The method of claim 12, wherein the artificial neural network is trained with historical adversary attack data, pre-incident indicator data, and combinations thereof.
